(19) United States
(12) Patent Application Publication
(10) Pub. No.: US 2018/0225656 A1
(43) Pub. Date: Aug. 9, 2018

(54) TRANSMITTING SENSITIVE DATA FROM A DIGITAL WALLET ON A USER DEVICE TO A DESIGNATED SERVER FOR USE BY A TRANSACTION CARD APPLICATION PROCESS

(71) Applicant: MasterCard International Incorporated, Purchase, NY (US)

(72) Inventors: Saurav Ray, Summerdale (SG); Manohar Murali, Singapore (SG); Prashant Sharma, Madison, NJ (US); Manash Bhattacharjee, Jersey City, NJ (US)

(21) Appl. No.: 15/424,226

(22) Filed: Feb. 3, 2017

(51) Int. Cl. G06Q 20/36; G06Q 40/02

(52) U.S. Cl. CPC G06Q 20/36; G06Q 40/025

(57) ABSTRACT

A method of transmitting data from a digital wallet on a user device to a designated server for use by a transaction card application process on the designated server. The method includes receiving code data generated by scanning a code image using the digital wallet on the user device, the code image being associated with a transaction card offer. The code image includes encoded data relating to the transaction card, including an identity of the designated server. The method further includes displaying information relating to the transaction card application process on the user device, the displayed information being generated based at least in part on the code data. The method further includes transmitting, to the designated server, user data for use in the transaction card application process at least a portion of the user data being securely stored by the digital wallet.

### FIELD OF THE INVENTION

Exemplary embodiments described herein relate to transmitting sensitive data from a digital wallet on a user device to a designated server for use by a transaction card application process.

### BACKGROUND

The process of submitting a transaction card application requires a user to provide sensitive information relating to the user's identity and credit-worthiness. The process therefore requires the user to gather the sensitive information from various sources and to complete a transaction card application to submit the sensitive information to a transaction card issuer. This is time consuming and may lead to exposure of the sensitive information. The exposure of sensitive information can, in turn, lead to identity theft.

### SUMMARY

In one aspect, the disclosed embodiments provide a digital wallet providing server and a method of transmitting sensitive data from a digital wallet on a user device to a designated server for use by a transaction card application process on the designated server. The method includes receiving code data generated by scanning a code image using the digital wallet on the user device, the code image being associated with a transaction card offer. The code image includes encoded data relating to the transaction card, including an identity of the designated server. The method further includes displaying information relating to the transaction card application process on the user device, the displayed information being generated based at least in part on the code data. The method further includes determining whether an input received from the user device in response to the displayed information indicates continuation of the transaction card application process. The method further includes transmitting, to the designated server, user data for use in the transaction card application process if it is determined that the input received from the user device indicates continuation of the transaction card application process, at least a portion of the user data being securely stored by the digital wallet.

Disclosed embodiments may include one or more of the following features. The method may include determining a likelihood of approval for the transaction card application process based at least in part on the user data and the code data. The code data may include parameters defining a salary requirement and a credit score requirement for the transaction card application process. The determining of the likelihood of approval may include comparing user data to the salary requirement and the credit score requirement parameters. The displayed information relating to the transaction card application process may include an indication of the determined likelihood of approval.

### BRIEF DESCRIPTION OF THE DRAWINGS

Features and advantages of the exemplary embodiments, and the manner in which the same are accomplished, will become more readily apparent with reference to the following detailed description taken in conjunction with the accompanying drawings.

FIG. 1 is a diagram depicting a system for transmitting sensitive data from a digital wallet on a user device to a designated server for use by a transaction card application process in accordance with disclosed embodiments;

FIG. 2 is a diagram depicting data flow for transmitting sensitive data from a digital wallet on a user device to a designated server for use by a transaction card application process;

FIGS. 3A-3C present a flowchart of a transaction card application process from the standpoint of the provider of the digital wallet;

FIG. 4 depicts an embodiment of a data element specification of a QR code used for providing an offer for a particular transaction card to a consumer;

FIG. 5 is a table showing parameters for the determination of transaction card application approval likelihood and two examples of such calculations;

FIG. 6 is a diagram depicting transaction card application information which may be received from a digital wallet provider;

FIG. 7 is a diagram depicting a device for performing methods for facilitating a transaction card application process in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various exemplary embodiments. It should be appreciated that various modifications to the embodiments are possible, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The exemplary embodiments described herein provide a system and method in which sensitive information is received from a user device to facilitate a transaction card application process on a designated server, e.g., a server associated with the transaction card issuer. There are at least two potential barriers which might deter consumers from applying for a new transaction card: (1) the application process requires the consumer to submit sensitive identification and credit information and is time consuming to complete; and (2) the application might be rejected, in which case there will be a negative impact on the consumer's credit rating (i.e., because the consumer is seeking to increase their total amount of credit) without any corresponding benefit to the consumer.

With respect to the first barrier, the disclosed embodiments facilitate a transaction card application by linking a cardholder's digital wallet to the card application process. For example, the card application process may electronically import secured sensitive data from a wallet provider server into a transaction card application server of the new card issuer. As a result, a digital wallet user can securely and easily facilitate the completion of a transaction card application process, often without requiring the consumer to fill out forms or track down information.

A digital wallet may be stored on an electronic device such as a computer, laptop, tablet, smart phone, and the like. Examples of a digital wallet include MasterCard MasterPass, Apple Pay, Google Wallet, and many others. Digital wallets can be used in-store and online and typically require authentication/authorization of the digital wallet user at the time of purchase such as a username, password, PIN, and the like. During enrollment, digital wallets require a user to provide sensitive information such as personal information, contact information, financial information, and the like. In some cases, a consumer has to enter as much information to sign up for a digital wallet as is needed to apply for a transaction card. As a result, a significant portion if not all of the information that is needed to complete a transaction card application is already securely stored by a digital wallet provider.

In some examples, the digital wallet provider may verify that the cardholder is an authorized user of the digital wallet and also authenticate the cardholder to determine that the cardholder is an authenticated user (i.e., the actual authorized user) of the digital wallet. Furthermore, in response to verifying/authenticating the digital wallet user, the digital wallet provider may transmit secure information about the digital wallet user previously stored by the digital wallet provider to the transaction card application server (e.g., the server of the new card issuer). Accordingly, in most cases, a transaction card application can be completed without requiring the digital wallet user to enter information or fill out a form.

With respect to the second barrier, the disclosed embodiments provide the consumer with an indication of the likelihood (e.g., a probability percentage) that the consumer's new transaction card application will be approved. For example, the new transaction card issuer might determine an approval likelihood based on consumer identifying information and information indicative of credit-worthiness, e.g., the consumer's income and credit score. The information indicative of credit-worthiness may be compared to requirements for the new transaction card, e.g., income and credit score requirements. These requirements may be obtained from a QR code scanned by the consumer, which is provided in an offer for the new transaction card. The QR code may also provide information on the various benefits provided by the new transaction card, such as, for example, balance transfer offers, awards and bonus amounts of airline mileage points arising from the application for and use of the transaction card and various other consumer benefits. As a result, the consumer can weigh the likelihood of approval against any disadvantages which might arise from the application process itself, e.g., an indicator being added to the consumer's credit report indicating that additional credit has been sought by the consumer.

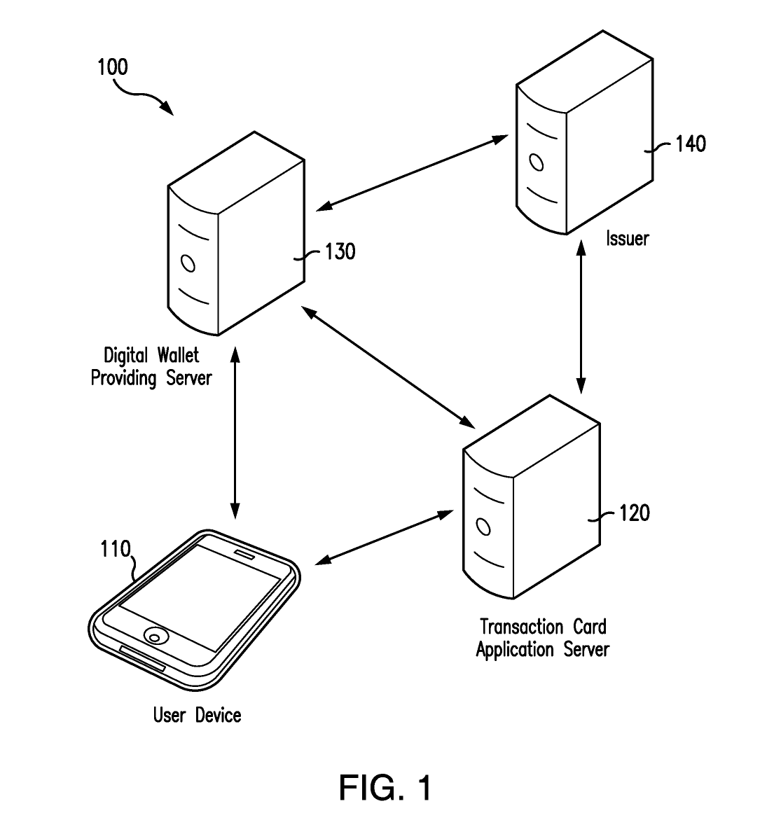

FIG. 1 illustrates a system 100 for transmitting sensitive data from a digital wallet on a user device to a designated server for use by a transaction card application process. Referring to FIG. 1, the system 100 includes a user device 110, a transaction card application device 120, a wallet providing device 130, and a transaction card issuer 140. It should also be appreciated that additional devices not shown may be included in the system 100 such as a payment gateway, an acquirer, and any other devices. The devices within the system 100 may connect to one another via a wired or wireless connection through a network (e.g., Internet, private network, etc.), direction connection, and the like. In this example, it is assumed that the user device 110 has a digital wallet installed therein that is hosted by the wallet provider 130 (e.g., server). It is also assumed that the digital wallet includes at least one payment account therein which may correspond to a bank, a credit agency, or other type of financial institution. It is assumed that the user device 110 is being used to initiate a transaction card application for a new payment account (e.g., credit card, debit card, check card, etc.) that is issued by the issuer 140 (e.g., server). The issuer 140 is associated with the transaction card application device 120 (e.g., server). For example, the issuer 140 may process transaction card applications using the transaction card application device 120. The user device 110 may include any device capable of using a digital wallet such as, for example, a mobile device, a computer, a laptop, a tablet, a mobile phone, a kiosk, an appliance, and the like.

When the selection to initiate the transaction card application is received by the transaction card application server 120, the server 120 can contact a corresponding wallet providing server (e.g., secure channel) of the respective digital wallet of the current user. According to various aspects, the transaction card application server 120 may be able to contact any number of different digital wallet providers and is not limited to a specific digital wallet provider.

According to various embodiments, when a digital wallet user selects the option to initiate a transaction card application, the transaction card application server 120 can receive secure cardholder information of the digital wallet (e.g., secure information of the user) from the wallet provider 130. Also, before the sensitive information is transmitted from the wallet provider 130 to the transaction card application server 120, an authorization process and/or an authentication process may be performed by the digital wallet provider 130 and/or the issuer 140 to authorize and/or authenticate the digital wallet user.

According to various aspects, the digital wallet provider 130 and/or the issuer 140 may perform an authorization/authentication process via a window displayed in association with the transaction card application website hosted by the transaction card application server 120 (or another server associated with the transaction card application server 120). The window may be displayed on the user device 110 in association with a display of the transaction card application website (e.g., embedded within, overlaying, to the side, etc.). In one embodiment, the window may be a lightbox or an iframe that captures data directly from a user of the user device 110 and transmitted directly to the wallet provider 130 and/or the issuer 140 without passing through the transaction card application server 120. Accordingly, particular types of sensitive user data may be transmitted to the wallet provider 130 without being stored or received by the transaction card application server 120 and/or the issuer 140. For example, the user data used to authenticate the digital wallet user may include a username, password, security code, PIN, and the like, which the user does not wish to share with the issuer 140 and/or the associated transaction card application server 120.

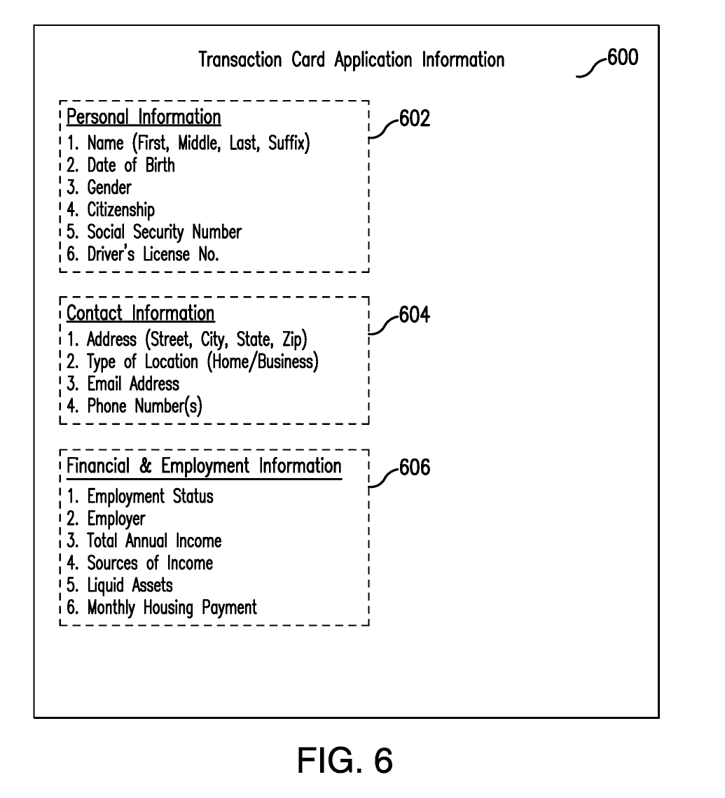

In response to the digital wallet user of the user device 110 successfully being verified by an authorization/authentication process, the wallet provider 130 may transmit/communicate with the transaction card application server 120 and provide the transaction card application server 120 with previously stored information about the digital wallet user of the user device 110 to complete the transaction card application. For example, the wallet provider 130 and the transaction card application server 120 may communicate with each other via a secured communications channel. In some cases, the transaction card application server 120 may request specific information from the wallet provider 130. As another example, the wallet provider 130 may identify all information stored by the wallet provider 130 that is needed by the transaction card application server 120 to complete the transaction card application. An example of the information that may be provided from the wallet provider 130 to the transaction card application server 120 is shown in FIG. 6, which is further described below. Based on the information about the digital wallet user that is received from the wallet provider 130, the transaction card application server 120 may complete the transaction card application by the digital wallet user of the user device 110. In some cases, the wallet provider 130 may provide all of the information to the transaction card application server 120 that is needed to complete the transaction card application. As another example, the wallet provider 130 may provide some information, and the remaining information may be input by the user (e.g., income, mortgage payments, etc.).

According to various aspects, the flow of the user's identifying information is between a digital wallet providing device (e.g., a repository) and the transaction card application server over a secure channel. In some examples, a successful authorization and/or authentication of the user may trigger the transfer of the user's information to the transaction card application server without requiring the user to enter application information or fill out an entire application form.

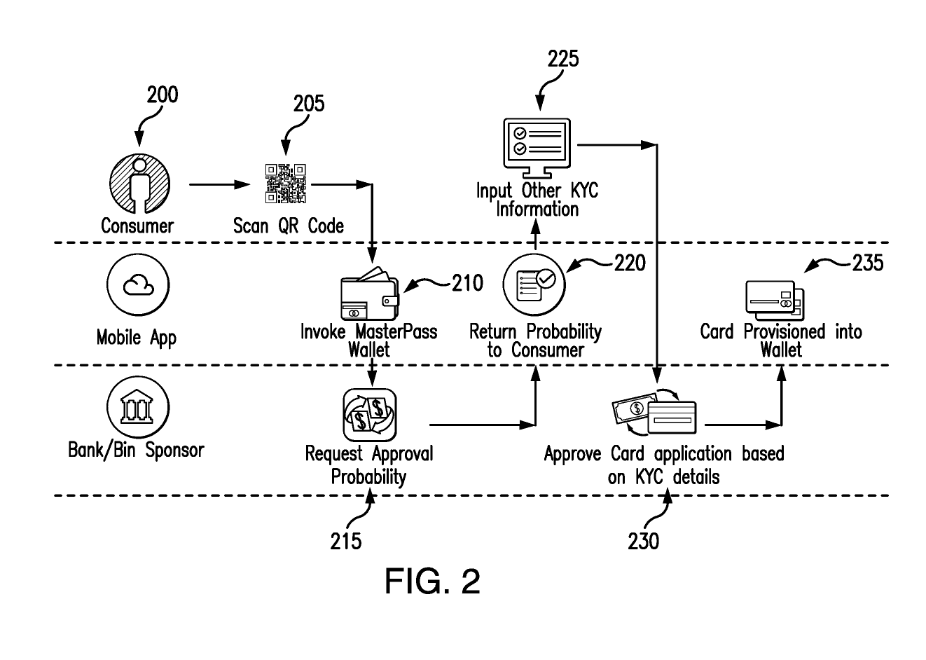

FIG. 2 is a diagram depicting data flow for transmitting sensitive data from a digital wallet on a user device to a designated server for use by a transaction card application process. To initiate the transaction card application process, the consumer 200 scans a code image, e.g., a QR code 205, provided in an advertisement, i.e., offer, for the transaction card. The scanning may be performed by the mobile app through which the consumer accesses their digital wallet 210. In disclosed embodiments, the data from the QR code is decoded by the digital wallet application on the user's device (e.g., the, consumer's mobile device) so that information relating to the offer transaction card offer may be presented to the user. The data obtained from the QR code is transmitted, along with consumer identifying and credit-worthiness data, to an application 215 which returns an indication (e.g., a probability percentage or probability score) of the likelihood that the transaction card application will be approved 220. In disclosed embodiments, the approval likelihood determination is performed on a server associated with the provider of the digital wallet. Alternatively, the approval likelihood determination may be performed on a server associated with the issuer of the transaction card which is the subject of the application process.

As noted above, the approval likelihood determination provides to the consumer an indication of the likelihood that the transaction card application will be approved. For example, the approval likelihood application may return the result of this determination to a mobile app on the user's device, such as, for example, the mobile app which implements the user's digital wallet. The approval likelihood result may be presented to the user as text, numbers, and/or graphics in various forms. For example, the approval likelihood result may be expressed as a probability percentage or score with a qualitative word or phrase, e.g., “90% Excellent,” “50% Poor,” etc.

If the user, after receiving the approval likelihood indication, decides to proceed with the transaction card application process, then identifying and credit-worthiness data relating to the user is transmitted to the transaction card application server. Any information required by the transaction card application process which is not included in the transmitted information, e.g., other “know your customer” (KYC) information, may be supplemented by information manually entered by the user via the user's device 225.

The data obtained in the transaction card application process is transmitted to the issuer of the transaction card. The issuer of the transaction card may be the issuer associated with the user's digital wallet, but this is not necessarily the case. In disclosed embodiments, if the transaction card application is approved by the issuer 230, then a transaction card may be provisioned into the user's digital wallet 235 for immediate use. Alternatively, the transaction card may be sent to the user in a conventional manner, such as by mail.

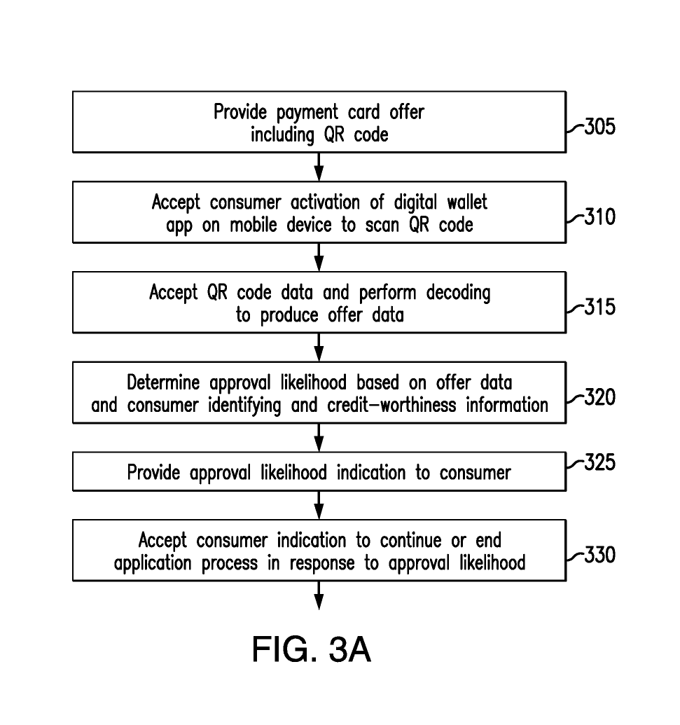

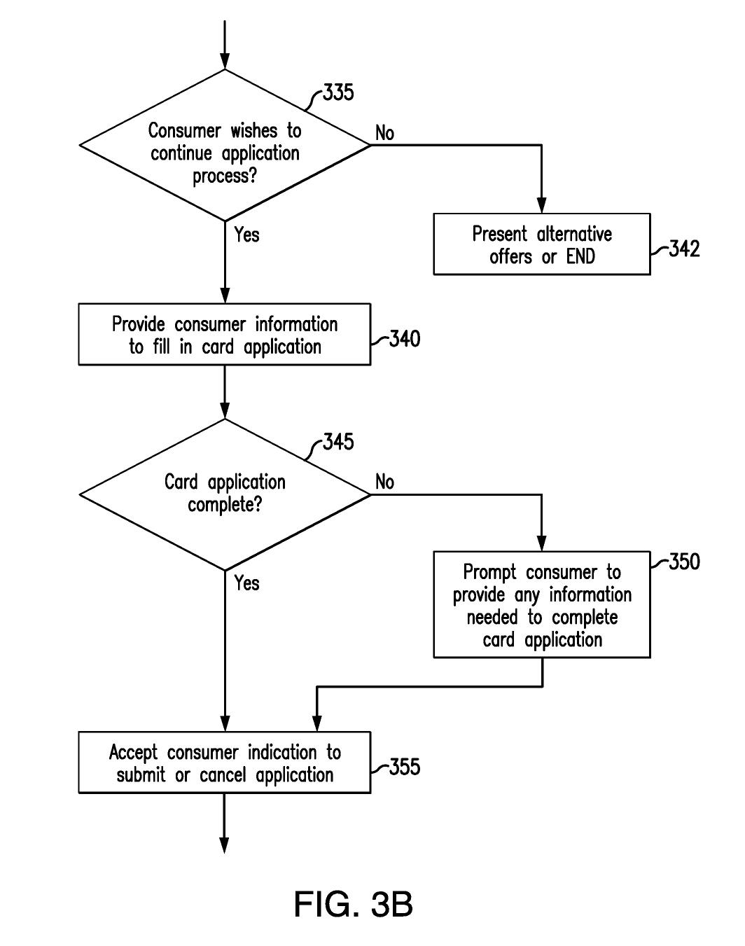

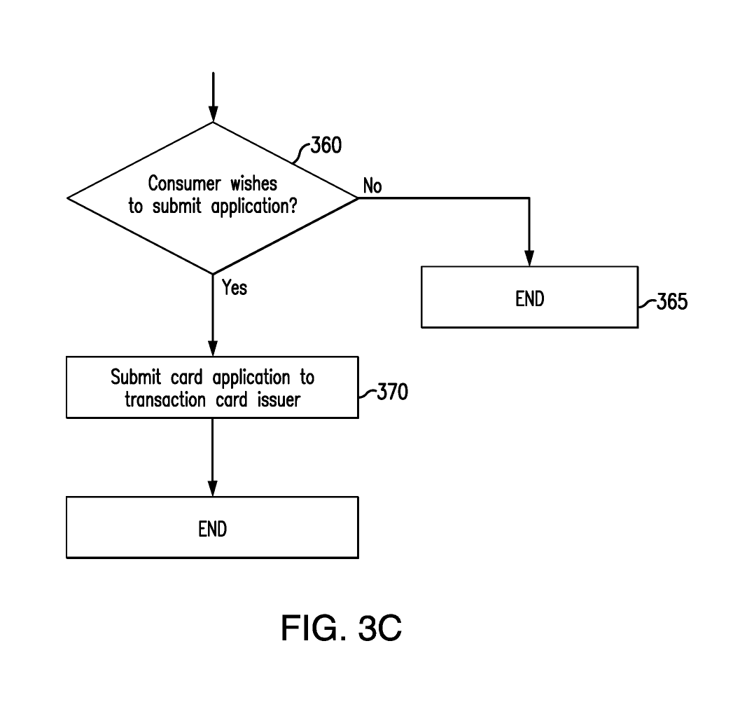

A flowchart of a transaction card application process from the standpoint of the user's digital wallet/digital wallet provider is shown in FIGS. 3A-3C. The transaction card issuer and the digital wallet provider seek to disseminate details relating to a particular transaction card that is to be offered to consumers. The transaction card issuer and the digital wallet provider also want to make it easy for consumers to apply for the particular transaction card, especially those consumers who have a high likelihood of meeting the approval requirements associated with the particular transaction card. To achieve these goals, the transaction card issuer and/or the digital wallet provider may present an advertisement, i.e., an offer, for the particular transaction card in printed publication, via a website page, or through various other forms of advertising. In disclosed embodiments involving, e.g., a printed publication, the offer may include a Quick Response (QR) code (Step 305) to provide the consumer with information relating to the particular transaction card. A QR code is a matrix, i.e., two dimensional, barcode which is able to store a significant amount of data in the form of a visible code image, e.g., a printed barcode matrix image. The scanning of the QR code produces the data encoded therein, which is then decoded to provide the desired information. The specific configuration of the QR code is discussed in detail below.

As discussed above in the context of FIG. 2, the user scans the QR code using a mobile app on their device, e.g., the digital wallet. The activation of the QR code scanning functionality is accepted by the digital wallet and the QR code is scanned (Step 310). In disclosed embodiments, an app other than the digital wallet may be used to perform the scanning, e.g., a separate transaction card offer app, in which case the steps described as being performed via the digital wallet would instead be performed via the transaction card offer app. The scanning of the QR code image produces the QR code data, which is accepted and interpreted, i.e., decoded, by the digital wallet (Step 315) or separate transaction card offer app. Alternatively, the digital wallet may transmit the QR code data without performing decoding. The QR code data, along with customer identifying and credit-worthiness related data, is transmitted to an application or a server for further processing.

The further processing which follows the decoding of the QR code data includes an application or process which determines a likelihood of approval of the transaction card application based on the consumer identifying and credit-worthiness data (Step 320). In disclosed embodiments, if the consumer identifying and credit-worthiness data available at this stage is insufficient to make a likelihood of approval determination, then the consumer may be prompted to enter additional information or such information may be obtained from other accessible sources. For example, if a consumer's credit score is not available from the information stored in the digital wallet, then the digital wallet may retrieve such information from credit reporting agencies.

In disclosed embodiments, the likelihood of approval may be performed by the digital wallet. In disclosed embodiments, the approval likelihood application is resident on a server associated with the provider of the digital wallet. Alternatively, the approval likelihood application may be resident on a server associated with the issuer of the transaction card which is the subject of the application process. The approval likelihood result may be provided to the user in the form of text, numbers, and/or graphics in various forms (Step 325).

After being notified of the approval likelihood, the process accepts from the consumer an indication of whether to proceed with or end the transaction card application process (Step 330). Based on this input, the process determines whether the consumer wishes to proceed (Step 335) and if so, the digital wallet (or transaction card offer app) provides customer information to fill in the transaction card application (Step 340). If it is determined that the consumer does not wish to proceed, then the transaction card application process ends (Step 342). In disclosed embodiments, if the consumer does not wish to proceed, then the consumer may be presented with alternative offers, such as, for example, offers for transaction cards with less stringent credit-worthiness requirements. The alternative offers may be presented with an approval likelihood indication determined in the manner discussed above.

A determination is made as to whether the transaction card application is complete based on the consumer information stored in, or accessible to, the digital wallet (Step 345). If the transaction card application is not complete, then the consumer is prompted to provide any additional information (Step 350), such as, for example, alternative phone numbers or addresses not accessible by the digital wallet. An input from the consumer is then solicited (Step 355) to determine whether the consumer wishes to submit or cancel the transaction card application (Step 360). If it is determined that the consumer wishes to cancel the application, then the process ends (Step 365). An option may be provided to allow the consumer to store the transaction card application data for completion at a later time. If it is determined that the consumer wishes to submit the application, then it is transmitted to the transaction card issuer (Step 370) and the process ends.

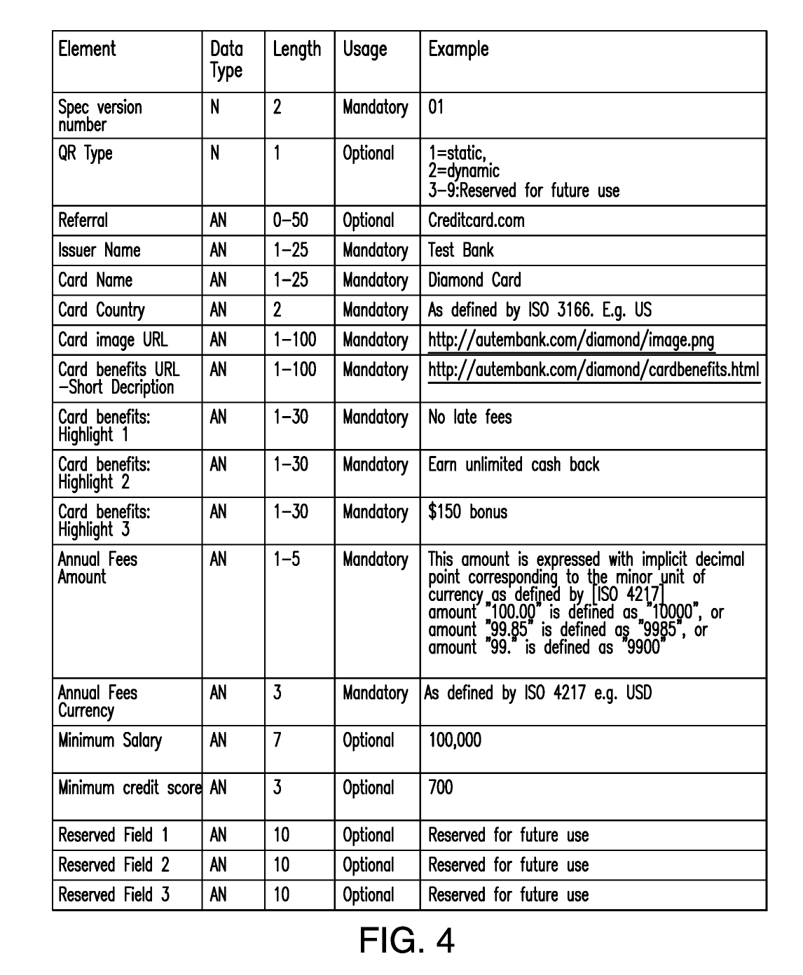

FIG. 4 depicts an embodiment of a data element specification of a QR code used for providing an offer for a particular transaction card to a consumer. Each of the data elements has a name, data type (e.g., numeric or alphanumeric), and length. A “usage” field defines whether each element is mandatory or optional. The term “mandatory” means that, in a particular embodiment of the disclosed invention, the data element should be included because the transaction card application process expects to receive the data element. However, the term “mandatory” does not mean that the data element so identified is required in each and every embodiment of the disclosed invention. For example, in particular embodiments, a third card benefit (i.e., the data element “Card benefits: Highlight 3”) may be optional rather than mandatory. In other embodiments, only two card benefit elements may be defined. The QR code specification includes an “Example” field which provides an example of each particular data element and/or explanatory notes, such as, for example, a reference to a particular industry specification for defining the format and/or content of the data element in question.

Some of the data elements are used to control the transaction card application process. For example, the data element “Spec version number” allows each particular QR code specification to be given a serial identifier so that updates to the specification will be recognized by the transaction card application process. The data element “QR Type” can be used to define a static or dynamic QR code, and other possible distinctions in future versions. Other data elements relate to the characteristics of the particular transaction card which is the subject of the application process, e.g., Issuer Name, Card Name, Annual Fees Amount, Card benefits: Highlights 1, etc., or the income and credit-worthiness requirements of the transaction card, e.g., Minimum Salary and Minimum Credit Score. In disclosed embodiments, data elements relating to the income and credit-worthiness requirements of the particular transaction card are compared to the consumer's income and credit score in the determination of approval likelihood, as discussed in further detail below.

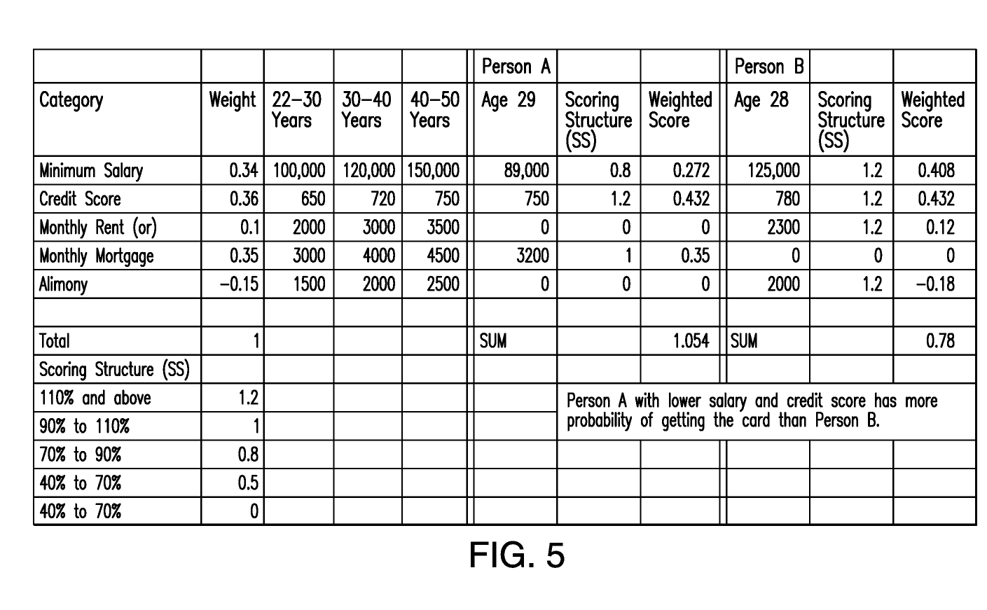

FIG. 5 is a table showing parameters for the determination of transaction card application approval likelihood and two examples of such calculations, for “Person A” and “Person B,” for a particular embodiment. In the depicted embodiment, the transaction card under consideration has five categories of requirements: minimum salary, credit score, monthly rent or mortgage, and alimony. Each category is given a weight between zero and one (e.g., 0.34, 0.36, 0.1, 0.35, −0.15) and the weights add up to one. For each category, e.g., minimum salary, a nominal value for the category (e.g., $100,000, $120,000, and $150,000) is given for each of three age brackets (e.g., 22-30, 30-40, and 40-50 years, respectively).

In the example depicted in FIG. 5, Person A is 29 years old and there is a specific value for each category which has been obtained in the transaction card application process discussed, e.g., with respect to FIGS. 3A-3C. In this example, Person A has a salary of $89,000, a credit score of 750, a monthly rent of $0, a monthly mortgage of $3200, and no alimony payment. Each of these values is compared to the nominal value for the category to compute a relative percentage difference. The difference percentage is compared to a scoring structure to obtain a score. For example, Person A's salary of $89,000 is 89% of the nominal minimum salary for Person A's age range, i.e., $100,000. According to the scoring structure, values between 70% and 90% of the nominal value are assigned a score of 0.8. The score is multiplied by the weighting factor (e.g., 0.34) to obtain a weighted score of 0.272 for the minimum salary category for Person A. The weighted scores are summed for all of the categories to determine a total score, e.g., 1.054 for Person A.

Another example calculation is shown for Person B, who has a higher salary and a higher credit score than Person A. However, because Person B pays rent (e.g., $2000) instead of having a mortgage, and has an alimony payment to make, Person B's total score of 0.78 is significantly less than that of Person A. This means that Person B has a lower likelihood of having a transaction card application accepted for this particular card.

The calculated total score for each person is evaluated against a defined standard to determine the likelihood of approval. In the example depicted in FIG. 5, there may be a defined cutoff of 1.0 for likely approval versus likely rejection. In such a case, Person A may be informed that they are likely obtain approval of the application, whereas Person B may be informed that it is unlikely they will obtain approval of the application. The defined approval standard may be established in various ways. For example, the defined approval standard may be obtained based on a subjective and/or qualitative assessment of the total score. Alternatively, the defined approval standard may be based on historical approval data for the particular transaction card and/or the particular transaction card issuer. The defined approval standard may be divided into ranges which connote a degree or probability of approval. For example, total scores above 1.0 may be denoted “highly likely,” total scores between 0.9 and 1.0 may be denoted “likely,” total scores between 0.8 and 0.9 may be denoted “unlikely,” and total scores below 0.8 may be denoted “highly unlikely.”

FIG. 6 illustrates an example of transaction card application information 600 that may be received from a digital wallet provider, in accordance with an example embodiment. Referring to FIG. 6, the transaction card application information 600 may be previously stored by a wallet provider, and may be transmitted by the wallet provider server to a transaction card application server. The information may include personal information 602 such as name, date of birth, gender, citizenship, social security number, driver's license number, and the like. The application information may include contact information 604 such as residence information, email information, phone number information, and the like. The application information may also include financial information 606 such as employer information, income information, credit information, housing information, and the like. It should be appreciated that the application information that may be provided to the transaction card application server is not limited by what is shown and described with respect to FIG. 6, but may include any information that is used to complete a transaction card application by the user.

The digital wallet providing server may verify the digital wallet user requesting the transaction card application is an authorized user of the digital wallet via a window that is displayed by the digital wallet provider in association with the transaction card application website. For example, a window may be displayed so as to overlay a window displaying the transaction card application website. In this example, the window provided by the wallet provider may include one or more fields for inputting/receiving authorization and/or authentication information. Using the window, the user may input information and the wallet providing server may authorize and authenticate the user via one or more security protocols. For example, the authorization and authentication may include one or more of a password, username, account PIN number, and the like.

In response to verifying the digital wallet user is an authorized user, the system transmits previously stored information of the digital wallet account of the user to the transaction card application server for completing the card application by the digital wallet user. For example, the information for completing the card application of the digital wallet user may include the information shown in FIG. 6, or additional or different information. In some embodiments, the transmitting may include identifying all user data needed for completion of the transaction card application that is already stored at the digital wallet providing server and transmitting the identified information to the transaction card application server. As another example, the transmitting may include receiving a request for specific information about the digital wallet user from the transaction card application server. According to various embodiments, the previously stored secure information of the digital wallet that is transmitted to the transaction card application server may include personal information of the digital wallet user, financial information of the digital wallet user, contact information of the digital wallet user, and the like. In some examples, the secure information of the digital wallet user may be transmitted over a secured channel between the transaction card application server and the digital wallet providing server.

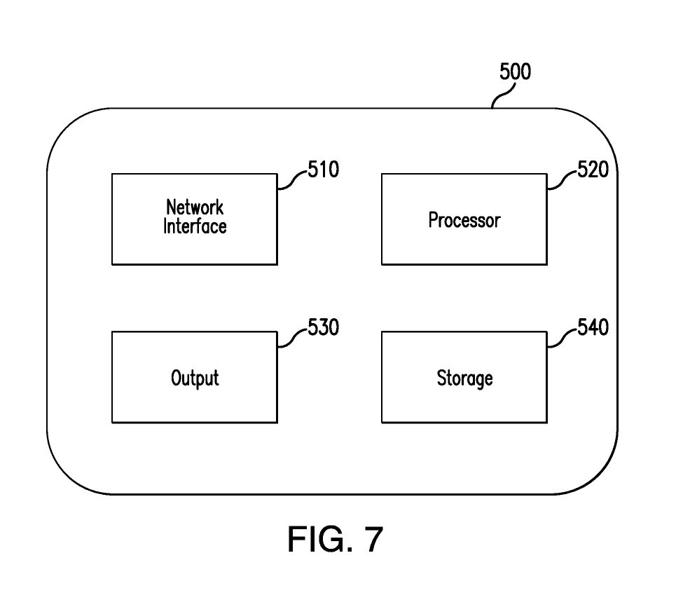

FIG. 7 illustrates a device 500 for facilitating transaction card application in accordance with an example embodiment. For example, the device 500 may be the wallet providing server 130 of FIG. 1, or another device. Referring to FIG. 7, the device 500 includes a network interface 510, a processor 520, an output 530, and a storage device 540. Although not shown in FIG. 7, the device 500 may include other components such as a display, an input unit, a receiver/transmitter, and the like. Also, the network interface 510 may also be referred to as a transmitter, a receiver, a transmitter, and/or the like. The network interface 510 may transmit and receive data over a network such as the Internet, a private network, a public network, etc. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the device 500, an externally connected display, a cloud, another device, and the like. The storage device 540 is not limited to any particular storage device and may include any known memory device such as RAM, ROM, hard disk, and the like.

According to various embodiments, the storage 540 may store data about existing digital wallet users, for example, sensitive information such as personal information, contact information, employment information, credit information, and the like. The processor 520 may verify that the digital wallet user is an authorized user of the digital wallet via a window associated with the transaction card application website. Here, the processor 520 may perform authorization and authentication of the user by requesting information from the user. For example, the processor 520 may display a window in association with the transaction card application website and receive user data from inputs via the window. In some examples, the information may be captured by the digital wallet provider without passing through or being stored by the transaction card application server.

In response to the processor 520 verifying the digital wallet user is an authorized user, the processor 520 may control the network interface 510 to transmit previously stored secure information of the digital wallet stored in the storage 540 to the transaction card application server for use in completing the transaction card application of the digital wallet user. For example, the processor 520 may identify all user data needed for completing a transaction card application, i.e., user data stored at the digital wallet providing server, and control the network interface 510 to transmit all the identified information to the transaction card application server. As another example, the processor 520 may identify as much information as the storage 540 has stored therein that can be used to fill in the transaction card application even in situations where additional information is needed. In this example, the transaction card application server may further request information from the user to supplement the information provided by the wallet providing device 500.

In disclosed embodiments, a method may be performed by the transaction card application server 120 shown in FIG. 1, or another device, which may have a structure similar to the device 500 depicted in FIG. 7. The method includes receiving, at the transaction card application server, a request to begin a transaction card application process. The request may be from a digital wallet user who has scanned a QR code in a transaction card offer.

According to various embodiments, a digital wallet provider may perform an authorization and an authentication of the digital wallet user and provide an indication of the successful authorization/authentication to the transaction card application server. For example, the transaction card application server may query the digital wallet provider or the digital wallet provider may provide a notification of the successful authorization/authentication to the transaction card application server. As another example, the wallet provider may provide notification of a failure in the authorization or authentication process. In response to the user of the digital wallet being successfully verified as an authorized user by a digital wallet provider, the transaction card application server may receive secure information of the digital wallet previously stored by the digital wallet providing server. For example, the transaction card application server may receive user data stored at the digital wallet providing server that is needed for completing an application of the digital wallet user for a transaction card, such as, for example, personal information, credit history and credit-worthiness information, financial information, contact information, and the like.

The method includes filling in identifying information of the user of the digital wallet in a transaction card application based on the secure information of the digital wallet that is received from the digital wallet providing server. Furthermore, once the user has completed the card application, the transaction card application server may calculate a likelihood of approval of the application, as discussed above.

In view of the above, it is apparent that the example embodiments provide a system and method for diminishing the barriers to transaction card application by making use of pre-loaded data of a user which is already stored at a digital wallet providing server. For example, the system and methods herein may directly import data from a digital wallet (e.g., personal information, contact information, etc.) into a server controlling the application for the transaction card thereby relieving the user from entering any information during a transaction card application process or reducing the amount of information needed to be input during the application process such as such as a username, password, security questions, or the like.

As used herein and in the appended claims, the term “payment card account” includes a credit card account, a deposit account that the account holder may access using a debit card, a prepaid card account, or any other type of account from which payment transactions may be consummated. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” or “payment system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

As used herein, the term account may refer to a card, transaction card, financial transaction card, payment card, and the like, refer to any suitable transaction card, such as a credit card, a debit card, a prepaid card, a charge card, a membership card, a promotional card, a frequent flyer card, an identification card, a gift card, and the like, and also refer to any suitable payment account such as a deposit account, bank account, credit account, and the like. As another example, the terms may refer to any other device or media that may hold payment account information, such as mobile phones, Smartphones, key fobs, computers, and the like. The transaction card can be used as a method of payment for performing a transaction.

As will be appreciated based on the foregoing specification, the above-described examples of the disclosure may be implemented using computer programming or engineering techniques including computer software, firmware, hardware or any combination or subset thereof.

The computer programs (also referred to as programs, software, software applications, “apps”, or code) may include machine instructions for a programmable processor, and may be implemented in a high-level procedural and/or object-oriented programming language, and/or in assembly/machine language.

The above descriptions and illustrations of processes herein should not be considered to imply a fixed order for performing the process steps. Rather, the process steps may be performed in any order that is practicable, including simultaneous performance of at least some steps.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method of transmitting data from a digital wallet on a user device to a designated server for use by a transaction card application process on the designated server, the method comprising:
receiving code data generated by scanning a code image using the digital wallet on the user device, the code image being associated with a transaction card offer, the code image comprising encoded data relating to the transaction card, including an identity of the designated server;
displaying information relating to the transaction card application process on the user device, the displayed information being generated based at least in part on the code data;
determining whether an input received from the user device in response to the displayed information indicates continuation of the transaction card application process; and
transmitting, to the designated server, user data for use in the transaction card application process if it is determined that the input received from the user device indicates continuation of the transaction card application process, at least a portion of the user data being securely stored by the digital wallet.

2. The method of claim 1, wherein the user data comprises at least one of user identifying information and user credit-worthiness information.

3. The method of claim 1, wherein the user data is transmitted over a secured channel between a digital wallet providing server and the designated server.

4. The method of claim 1, wherein the user data comprises data stored by the digital wallet and data entered by a user in the transaction card application process.

5. The method of claim 1, further comprising determining a likelihood of approval for the transaction card application process based at least in part on the user data and the code data.

6. The method of claim 5, wherein the code data comprises parameters defining a salary requirement and a credit score requirement for the transaction card application process.

7. The method of claim 6, wherein the determining of the likelihood of approval comprises comparing user data to the salary requirement and the credit score requirement parameters.

8. The method of claim 5, wherein the displayed information relating to the transaction card application process comprises an indication of the determined likelihood of approval.

9. The method of claim 1, wherein the transaction card application process comprises providing at least a portion of the user data to at least partially complete a transaction card application form.

10. The method of claim 9, wherein the transaction card application process comprises prompting the user to provide missing data for the transaction card application form.

11. A digital wallet providing server for transmitting data from a digital wallet on a user device to a designated server for use by a transaction card application process on the designated server, the digital wallet providing server comprising a processor and a network interface, the processor being configured to execute a method comprising:
receiving, via the network interface, code data generated by scanning a scannable code image using the digital wallet on the user device, the code image being associated with a transaction card offer, the code image comprising encoded data relating to the transaction card, including an identity of the designated server;
generating displayable information relating to the transaction card application process based at least in part on the code data for display on the user device;
determining whether an input received from the user device in response to the displayed information indicates continuation of the transaction card application process; and
transmitting, to the designated server via the network interface, user data for use in the transaction card application process if it is determined that the input received from the user device indicates continuation of the transaction card application process, at least a portion of the user data being securely stored by the digital wallet.

12. The digital wallet providing server of claim 11, wherein the user data comprises at least one of user identifying information and user credit-worthiness information.

13. The digital wallet providing server of claim 11, wherein the user data is transmitted over a secured channel between a digital wallet providing server and the designated server.

14. The digital wallet providing server of claim 11, wherein the user data comprises data stored by the digital wallet and data entered by a user in the transaction card application process.

15. The digital wallet providing server of claim 11, further comprising determining a likelihood of approval for the transaction card application process based at least in part on the user data and the code data.

16. The digital wallet providing server of claim 15, wherein the code data comprises parameters defining a salary requirement and a credit score requirement for the transaction card application process.

17. The digital wallet providing server of claim 16, wherein the determining of the likelihood of approval comprises comparing user data to the salary requirement and the credit score requirement parameters.

18. The digital wallet providing server of claim 15, wherein the displayed information relating to the transaction card application process comprises an indication of the determined likelihood of approval.

19. The digital wallet providing server of claim 11, wherein the transaction card application process comprises providing at least a portion of the user data to at least partially complete a transaction card application form.

20. The digital wallet providing server of claim 19, wherein the transaction card application process comprises prompting the user to provide missing data for the transaction card application form.
